(19) United States
(12) Patent Application Publication
(10) Pub. No.: US 2001/0050643 A1
(43) Pub. Date: Dec. 13, 2001

(54) Small-size broad-band printed antenna with parasitic element

(76) Inventors: Igor Egorov, Lund (SE); Anders Dahlstrom, Vellinge (SE)

Correspondence Address: BURNS DOANE SWECKER & MATHIS L L P, POST OFFICE BOX 1404, ALEXANDRIA, VA, 22313-1404, US

(21) Appl. No.: 09/507,673

(22) Filed: Feb. 22, 2000

(51) Int. Cl. H01Q 1/24

(52) U.S. Cl. 343/702; 343/700 MS

(57) ABSTRACT

A small, inexpensive, built-in planar inverted F-type antenna (PIFA) with a parallel meandering parasitic element having a wide bandwidth to facilitate wireless, short range communications between devices operating in the Bluetooth frequency range is disclosed. The parasitic element is placed on the same substrate as the main antenna element and is grounded at one end. The feeding pin of the PIFA is proximal to the ground pin of the parasitic element. The coupling of the meandering, parasitic element to the main antenna results in two resonances. These two resonances are adjusted to be adjacent to each other in order to realize a broader resonance.

### BACKGROUND

The present invention relates generally to radio communication systems and more particularly to small built-in antennas which can be incorporated into short range communication modules.

Communication between related pairs of devices over a short range (in terms of distance) is highly desirable. Examples of these related pairs of devices include a computer and a keyboard, a computer and a monitor, a computer and a computer mouse, a computer and a printer, a cellular phone and a hands-free set, a cellular phone and a computer, a VCR and a TV, a DVD player and a TV. A majority of these devices communicate using cables which often result in these devices having to be located in close proximity with each other. If related pairs of these devices are located further apart, the amount of cables used increases which leads to an unaesthetic appearance or in extreme cases, present safety concerns. Therefore, the ability to communicate between devices over a short range without the use of cables is needed.

In addressing this need, remote controls, wireless headphones and infrared connections between cellular phones and laptop computers have been developed. Each of these approaches however, used different techniques which are not compatible with others. Therefore, there exists a need for a uniform standard for wireless short range communications. Bluetooth is one standard that can address the concerns highlighted above.

Bluetooth is an example of a short range communication environment and is an open specification for wireless communication of both voice and data. It is based on a short-range, universal radio link, and it provides a mechanism to form small ad-hoc groupings of connected devices, without a fixed network infrastructure, including such devices as printers, PDAs, desktop computers, FAX machines, keyboards, joysticks, telephones or virtually any digital device. Bluetooth operates in the unlicenced 2.4 GHz Industrial-Scientific-Medical (ISM) band.

The original intention of Bluetooth was to eliminate cables between devices such as phones, PC-cards, wireless headsets, etc., in a short-range radio environment. Today, however, Bluetooth is a true ad-hoc wireless network technology intended for both synchronous traffic, e.g., voice and asynchronous traffic, e.g., IP (internet protocol) based data traffic. The aim is that any digital communication device such as telephones, PDAs, laptop computers, digital cameras, video monitors, printers, fax machines, etc. should be able to communicate over a radio interface, without the use of cables, through the use of Bluetooth radio chip and its accompanying software.

FIG. 1 illustrates a Bluetooth piconet. A piconet is a collection of digital devices, such as any of those mentioned above, connected using Bluetooth technology in an ad-hoc fashion. A piconet is initially formed with two connected devices, herein referred to as Bluetooth devices. A piconet can include up to eight Bluetooth devices. In each piconet, for example piconet 100, there exists one master Bluetooth unit and one or more slave Bluetooth units. In FIG. 1, Bluetooth unit 101 is a master unit and unit 102 is a Bluetooth slave unit.

As previously described, Bluetooth systems allow for wireless connectivity between, for example, mobile PCs, phones, digital cameras, proximity detectors, and other portable devices. Bluetooth systems may operate on the unlicenced 2.4 GHz band which poses some risk of connections collision with 802.11 wireless LANs. Bluetooth systems are nevertheless desirable due to their low power requirements coupled with the shortness of their range, e.g. up to 10 meters making them useful for interoffice wireless applications.

An important consideration in implementing a short range wireless communication between devices is cost. If, for instance, the above described Bluetooth implementation costs twice as much as a cable, then it will not be a suitable candidate. Another consideration is the size of the module that enables communication between devices. If the module doubles the size of one of the devices, such as a cellular phone, then it would not be a suitable candidate either.

An antenna is an important and perhaps an integral part of each short range wireless communication module implemented using the Bluetooth standard. This antenna has to incorporate all of the requirements described above. That is, the antenna has to facilitate short range wireless communication in the Bluetooth frequency of approximately 2.4 GHz. It also has to be manufactured at a low cost and be small in size. In addition, the antenna has to be functional at the Bluetooth frequency while having a considerable bandwidth. The bandwidth has to be greater than 100 MHZ in order to make the antenna tolerant to the variation in material parameters and the differences in the antenna's surroundings when the Bluetooth module with the antenna is inserted in various devices. The antenna has to facilitate communications in frequencies ranging from less than 2.4 GHz to frequencies greater than 2.5 GHz. The need for a greater bandwidth requirement stems from the fact that the antenna has to be tolerant to some shifts in center frequency due to material variations and changes in the antenna's surroundings. With respect to Bluetooth modules in particular, they may be equipped with different parts and components such as, for example, different plastic covers.

One of these requirements, namely, the need for a small size, may be satisfied by a planar inverted F antenna (PIFA). A high dielectric constant of substrate enables the PIFA antenna to be compact. The bandwidth, however, is rather narrow and not adequate for the short range wireless communication between devices operating under the Bluetooth standard. Furthermore, having fixed dimensions of the substrate makes it virtually impossible to increase the bandwidth even if the shape of the radiating element is changed.

A number of antenna designs have been concerned with increasing the bandwidth. Of these, the antenna of JP6069715 includes an inductive dielectric element in parallel to an inverted F-formed antenna to increase the bandwidth. This antenna, however, operates at a much lower frequency (i.e., in the 170 MHZ to 210 MHZ range) than the Bluetooth frequency (i.e., 2.4 GHz). As a result, this antenna is much bigger than one that is suitable for enabling communication between devices operating in the Bluetooth frequency range. The bandwidth is also much lower (approximately 40 MHZ) than that desired for devices operating under the Bluetooth (100 MHZ) standard.

The antenna of JP7022832, includes a quarter-wave micro strip parasitic element with an open end that is parallel to one side of a PIFA antenna for realizing a wide band. This antenna, however, consists of two separate parts (i.e., radiating elements) that do not have a common substrate. In addition, the feeding point of the radiating element is distant from the ground pin of the parasitic element which does not facilitate an increase of the bandwidth that is necessary.

Another antenna, disclosed in JP6232625, includes a main radiator and a sub radiator provided on an upper part of the main radiator. This antenna, however, operates in the GPS frequency band which is at a much lower frequency (i.e., 1450 MHZ) than the Bluetooth frequency (i.e., 2.4 GHz). The bandwidth of this antenna is also much lower (approximately, 50 MHZ) than desired.

The antenna of JP9260934 includes two radiation conductors that are arranged parallel to each other. As with two of the other antennas discussed above, this antenna also operates at a much lower frequency (i.e., 800 MHZ which corresponds to GSM) than the Bluetooth frequency (i.e., 2.4 GHz). The bandwidth in this case is also less than that desired.

Therefore, there exists a need for an inexpensive, small inverted PIFA antenna with wide bandwidth that facilitates short range, wireless communication at the Bluetooth frequency range.

### SUMMARY

The present invention overcomes the above-identified deficiencies in the art by providing a small, inexpensive PIFA antenna with a wide bandwidth to facilitate wireless, short range communications between devices operating in the Bluetooth frequency range. This antenna will be incorporated into the devices by being placed on the printed circuit board (PCB).

This is accomplished by placing a small meandering, parasitic element along the main PIFA antenna. This element is placed on the same substrate as the main antenna element and is grounded at one end. The coupling of the meandering, parasitic element to the main antenna results in two resonances. These two resonances can be adjusted to be adjacent to each other in order to realize a broader resonance.

### BRIEF DESCRIPTION OF THE DRAWINGS

The above objects and features of the present invention will be more apparent from the following description of the preferred embodiments with reference to the accompanying drawings, wherein:

FIG. 1 illustrates an exemplary Bluetooth piconet;

FIG. 2 illustrates a PIFA antenna;

FIG. 3 illustrates a PIFA antenna with a meandering parasitic element;

FIG. 4 illustrates the voltage standing wave ratio (VSWR) characteristics for the antenna of FIG. 2;

FIG. 5 illustrates the voltage standing wave ratio (VSWR) characteristics for the antenna of FIG. 3; and

FIG. 6 illustrates an exemplary communication device encompassing an antenna of the present invention.

### DETAILED DESCRIPTION

In the following description, for purposes of explanation and not limitation, specific details are set forth, such as particular circuits, circuit components, techniques, etc. in order to provide a thorough understanding of the present invention. However, it will be apparent to one skilled in the art that the present invention may be practiced in other embodiments that depart from these specific details. In other instances, detailed descriptions of well-known methods, devices, and circuits are omitted so as not to obscure the description of the present invention.

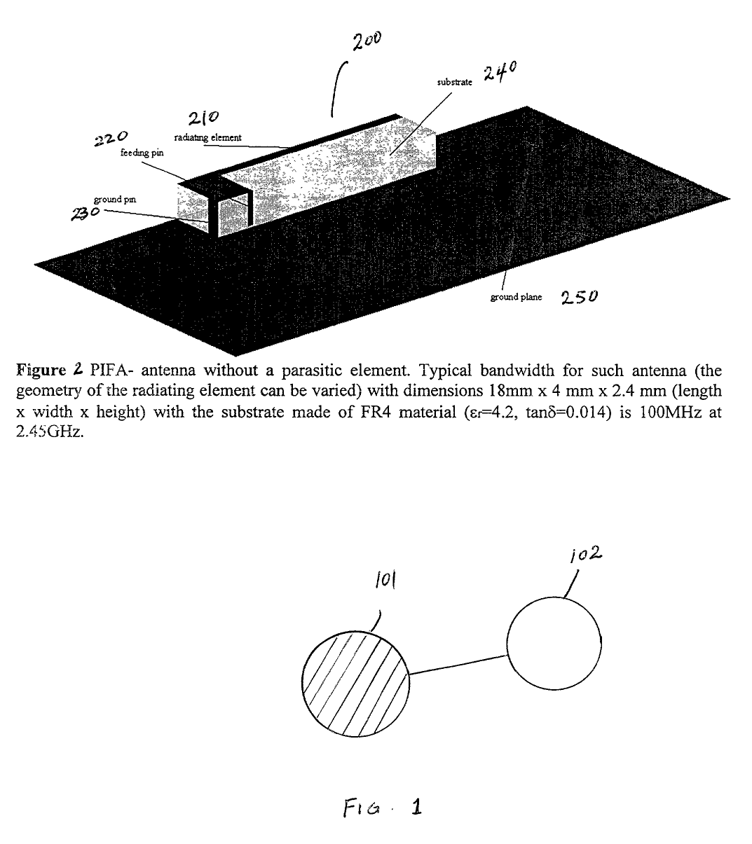

FIG. 2 illustrates an example of a conventional PIFA antenna 200. The PIFA antenna 200 includes a radiating element 210, a feeding pin 220 for the radiating element 210 and a ground pin 230 for connecting the radiating element 210 to a ground plane 250. The antenna 200 is placed on a substrate 240.

The bandwidth of the PIFA antenna of FIG. 2 is limited by the thickness of the substrate 240. Tuning of this antenna is achieved by the respective position of the feeding pin 220 and the ground pin 230. The positions of the feeding pin 220 and the ground pin 230, therefore, are the tuning parameters. Typical bandwidth for an antenna of this type is approximately 100 MHz at 2.45 GHz. As described, this frequency corresponds approximately to the Bluetooth frequency band. The dimensions of the substrate 240 of the ii illustrated PIFA antenna 200 are approximately 18 mm length, 4 mm width and 2.4 mm height. These particular dimensions enable this antenna to be placed in a communication device such as a cellular phone circuit board, for example. The substrate 240 is made of FR4 material which has a dielectric pemitivity (εᵣ) of 4.2 and a loss tangent (tan δ) of 0.014.

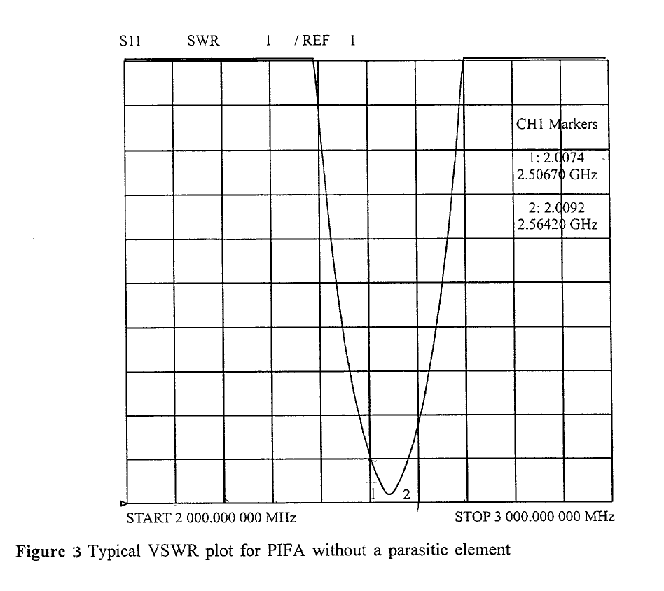

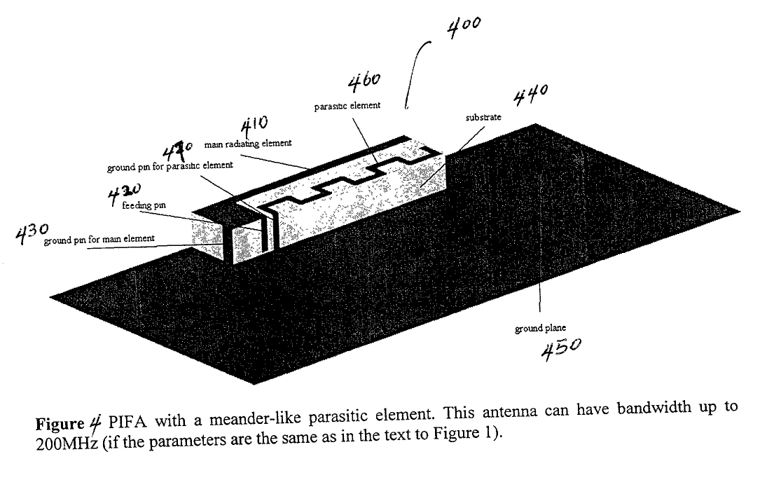

The voltage standing wave ratio (VSWR) of the PIFA antenna of FIG. 2 according to the dimensions specified above is illustrated in FIG. 3. As shown, for a ratio of less than 2:1, the bandwidth is approximately 80 MHZ.

In order to effectively utilize an antenna of this type (i.e., PIFA) within a Bluetooth module for enabling short-range, wireless communications, the bandwidth of 100 MHZ is inadequate. As described above, the antenna has to be tolerant to some shifts in center frequency due to material variations and variations in the antenna's vicinity.

Therefore, in order to satisfy the needs of short-range, wireless communication in the Bluetooth frequency band, a greater bandwidth than that which is available through the utilization of the PIFA antenna of FIG. 2 is highly desirable.

This limitation is overcome by exemplary embodiments of the present invention which provides a doubling of the bandwidth without altering the dimensions of the PIFA antenna of FIG. 2. This is realized by the addition of a parasitic, meandering radiating element in parallel with the radiating element 210 of FIG. 2.

According to an exemplary embodiment of the present invention which facilitates an increased bandwidth, as illustrated in FIG. 4, the antenna 400 comprises a main radiating element 410 (in the form of a PIFA), a feeding pin 420 for the main radiating element 410, and a ground pin 430 for connecting the main radiating element 410 to a ground plane 450. The main radiating element 410 (with the feeding pin 420 and ground pin 430) is placed on a substrate 440. In order to achieve a wider bandwidth, the antenna 400 of FIG. 4 comprises an additional element in the form of a meandering, parasitic element 460. The parasitic element 460 is connected to the ground plane 450 by a second ground pin 430.

The parasitic element 460 creates an additional resonance. This additional resonance can be adjusted so that it occurs near or adjacent the higher resonance frequency of the main antenna element 410. As a result, the two resonances merge into a broader resonance. According to exemplary embodiments of Applicants' invention, there are additional tuning parameters for the antenna 400 beside the thickness of the substrate 440, positions of the feeding pin 420 and ground pin 430. These additional parameters are the position of the ground pin 470 for the parasitic element 460, the distance between the main element 410 and parasitic element 460 as well as the length of each of the main element 410 and the parasitic element 460. In particular, to achieve a greater bandwidth, the distance between the feeding pin 420 of the main radiating element 410 and the ground pin 470 of the parasitic element 460 is minimized. This distance may, for example, be approximately 0.5 mm. The radiating element 410 and the parasitic element 460 also have a low-profile in order to enable the placement of the antenna on a circuit board of a cellular telephone, for example. This increased bandwidth overcomes any potential shifts in center frequencies discussed above.

In the alternative, a parasitic element, such as element 460, can be used to obtain a resonance that is distinct and separate (i.e., not adjacent) from the resonance of the main element if a particular application requires such an arrangement (i.e., two distinct resonances that do not merge into one resonance).

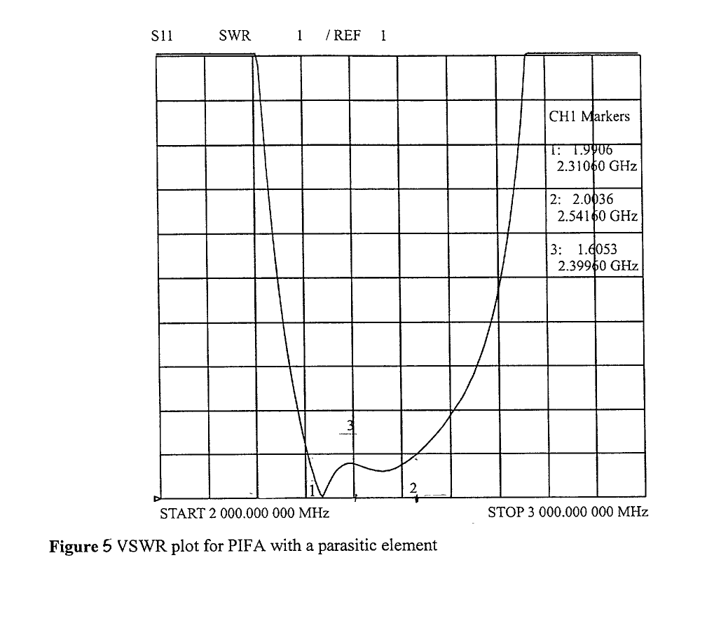

The dimensions of the substrate 440 are similar to that of substrate 240. The presence of the parasitic element 460 results in a much wider bandwidth. The VSWR for the antenna arrangement of FIG. 4 is illustrated in FIG. 5. As shown, for a VSWR of less than 2:1, the bandwidth is approximately 220 MHZ.

In order to illustrate the effectiveness of the present invention, FIG. 5 sets forth results of a simulation for the exemplary dual band patch antenna illustrated in FIG. 3. Purely for purposes of illustrating the present invention, the following values for the various parameters enumerated above for a semi built-in multi-band printed antenna may be used. The substrate 440 of FIG. 4, is 4 mm wide, 18 mm long and 2.4 mm high. The substrate may be FR4 material.

The type of material used for the substrate affects the antenna performance. Therefore, if the substrate material is altered (for example, from FR4 to some other material), the antenna may have to be re-tuned. If the dielectric constant (i.e., the permitivity constant) of the material is increased, the bandwidth decreases. The present invention, however, is not limited to FR4 material. Therefore, other materials with properties that are within reasonable limits of the properties of FR4 material will also provide an adequate bandwidth for the antenna of the present invention. The antenna 400 is made resonant at the Bluetooth frequency band/range.

FIG. 5 illustrates the VSWR performance of exemplary embodiments of the present invention. The bandwidth is about 220 MHZ at the Bluetooth frequency range for a VSWR of less than 2:1. As is evident from FIG. 5, this antenna meets the requirements of obtaining resonance and a wider bandwidth of approximately 220 MHZ in the Bluetooth frequency range.

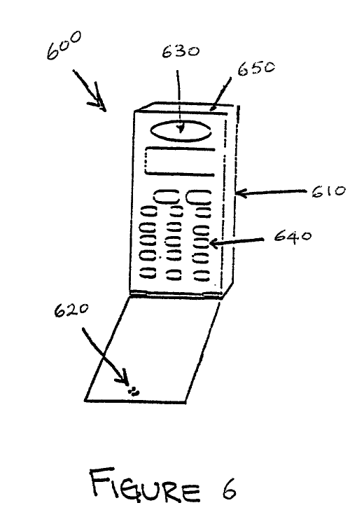

FIG. 6 illustrates an exemplary communication device, such as a cellular telephone 600 operating in the Bluetooth frequency range in which a PIFA antenna with a meandering parasitic element of the present invention may be implemented. Communication device 600 includes a chassis 610 having a microphone opening 620 and speaker opening 630 located approximately next to the position of the mouth and ear, respectively, of a user. A keypad 640 allows the user to interact with the communication device, e.g., by inputting a telephone number to be dialed. The communication device 600 also includes a PIFA antenna with a meandering, parasitic element 650.

The foregoing has described the principles, preferred embodiments and modes of operation of the present invention. However, the invention should not be construed as being limited to the particular embodiments discussed above. For example, while the antenna of the present invention has been discussed primarily as being a radiator, one skilled in the art will appreciate that the antenna of the present invention would also be used as a sensor for receiving information at specific frequencies. Similarly, the dimensions of the various elements (such as, the substrate) may vary based on the specific application. Thus, the above-described embodiments should be regarded as illustrative rather than restrictive, and it should be appreciated that variations may be made in those embodiments by workers skilled in the art without departing from the scope of the present invention as defined by the following claims.

What is claimed is:

1. A communication device for use in a short-range, wireless mode, said device comprising:
a receiver for allowing the communication device to receive information from a user;
a transmitter for allowing the communication device to transmit information to said user;
an input means;
a built-in planar inverted F-type antenna (PIFA) having a main radiating element located on a substrate within said communication device and tuned to a first frequency range; and
a parasitic element located on said substrate and tuned to a second frequency range that is different from said first frequency range.

2. The communication device of claim 1 wherein said first frequency range is lower than said second frequency range.

3. The communication device of claim 1 wherein said first frequency range is adjacent said second frequency range.

4. The communication device of claim 1 wherein said first and second frequency ranges form a continuous frequency range.

5. The communication device of claim 4 wherein said continuous frequency range includes the Bluetooth frequency band.

6. The communication device of claim 1 wherein said main radiating element has a length that is less than a length of the substrate.

7. The communication device of claim 1 wherein said main radiating element has a width that is less than a width of the substrate.

8. The communication device of claim 1 wherein the parasitic element is parallel to said main radiating element.

9. The communication device of claim 1 wherein the main radiating element further comprises a ground pin and a feeding pin.

10. The communication device of claim 9 wherein the parasitic element further comprises a ground pin.

11. The communication device of claim 10 wherein the feeding pin of the main radiating element is proximal to the ground pin of the parasitic element.

12. The communication device of claim 1 wherein the substrate is made of FR4 material.

13. A communication device for use in a short-range, wireless mode, said device comprising:
a built-in planar inverted F-type antenna (PIFA) having a main radiating element located on a substrate within said communication device and tuned to a first frequency range, and
a parasitic element located on said substrate and tuned to a second frequency range that is different from said first frequency range.

14. The communication device of claim 13 wherein said first frequency range is lower than said second frequency range.

15. The communication device of claim 13 wherein said first frequency range is adjacent said second frequency range.

16. The communication device of claim 13 wherein said first and second frequency ranges form a continuous frequency range.

17. The communication device of claim 16 where said continuous frequency range includes the Bluetooth frequency band.

18. The communication device of claim 13 wherein said main radiating element has a length that is less than a length of the substrate.

19. The communication device of claim 13 wherein said main radiating element has a width that is less than a width of the substrate.

20. The communication device of claim 13 wherein the parasitic element is parallel to said main radiating element.

21. The communication device of claim 21 wherein the main radiating element further comprises a ground pin and a feeding pin.

22. The communication device of claim 22 wherein the parasitic element further comprises a ground pin.

23. The communication device of claim 13 wherein the feeding pin of the main radiating element is proximal to the ground pin of the parasitic element.

24. The communication device of claim 13 wherein the substrate is made of FR4 material.
